(19) United States
(12) Patent Application Publication
(10) Pub. No.: US 2025/0158293 A1
(43) Pub. Date: May 15, 2025

(54) ANTENNA

(71) Applicant: KYOCERA CORPORATION, Kyoto-shi, Kyoto (JP)

(72) Inventors: Hiromichi YOSHIKAWA, Yokohama-shi, Kanagawa (JP); Satoshi ISHIKAWA, Yokohama-shi, Kanagawa (JP)

(21) Appl. No.: 18/835,020

(22) PCT Filed: Feb. 1, 2023
(86) PCT No.: PCT/JP2023/003239

§ 371 Date: Aug. 1, 2024

(30) Foreign Application Priority Data
Feb. 3, 2022 (JP) 2022-015566

(51) Int. Cl. H01Q 21/24; H01Q 1/36

(52) U.S. Cl. CPC H01Q 21/24; H01Q 1/36

(57) ABSTRACT

An antenna includes: a first substrate extending in a first plane direction; a first conductor, a second conductor, a third conductor, and a fourth conductor that are disposed on one surface of the first substrate and extend in the first plane direction; a coupling conductor disposed on another surface of the first substrate, the coupling conductor extending in the first plane direction, the coupling conductor capacitively coupling the first conductor, the second conductor, the third conductor, and the fourth conductor; a second substrate including one surface facing the other surface of the first substrate, the second substrate extending in the first plane direction; a first pin member; a second pin member; a third pin member; a fourth pin member; and a balun.

### TECHNICAL FIELD

The present disclosure relates to an antenna.

### BACKGROUND OF INVENTION

When two antennas are brought closer, an isolation therebetween cannot be ensured. To ensure the isolation between the antennas, there is a technique for separating the two antennas and inserting a structure therebetween. Such a technique is described, for example, in Patent Document 1.

### CITATION LIST

### Patent Literature

Patent Document 1: JP 2016-105583 A

### SUMMARY

An antenna of the present disclosure including: a first substrate extending in a first plane direction; a first conductor, a second conductor, a third conductor, and a fourth conductor that are disposed on one surface of the first substrate and extend in the first plane direction; a coupling conductor disposed on another surface of the first substrate, the coupling conductor extending in the first plane direction, the coupling conductor capacitively coupling the first conductor, the second conductor, the third conductor, and the fourth conductor; a second substrate including a ground conductor and a power supply point, the second substrate being separated from the first substrate in a first direction, the second substrate including one surface facing the other surface of the first substrate, the second substrate extending in the first plane direction; a first pin member configured to electromagnetically connect to the first conductor; a second pin member configured to electromagnetically connect to the second conductor; a third pin member configured to electromagnetically connect to the third conductor; a fourth pin member configured to electromagnetically connect to the fourth conductor; and a balun disposed on one surface of the second substrate to be electromagnetically connected to the power supply point.

### BRIEF DESCRIPTION OF THE DRAWINGS

FIG. 1 is a diagram for explaining an outline of an antenna according to an embodiment.

FIG. 2 is a top view illustrating a configuration example of an antenna according to a first embodiment.

FIG. 3 is a perspective view illustrating a configuration example of the antenna according to the first embodiment.

FIG. 4 is a view for explaining a wiring line pattern according to a comparative example.

FIG. 5 is a perspective view illustrating a configuration example of an antenna according to a second embodiment.

### DESCRIPTION OF EMBODIMENTS

In the following, an embodiment of the present invention will be described in detail with reference to the accompanying drawings. It should be noted that the present invention is not limited by the embodiments, and in the following embodiments, the same parts are denoted by the same reference numerals, and redundant description will be omitted.

In the following description, an XYZ orthogonal coordinate system is set, and the positional relationship between respective portions will be described by referring to the XYZ orthogonal coordinate system. A direction parallel to an X-axis in a horizontal plane is defined as an X-axis direction, a direction parallel to a Y-axis orthogonal to the X-axis in the horizontal plane is defined as a Y-axis direction, and a direction parallel to a Z-axis orthogonal to the horizontal plane is defined as a Z-axis direction. A plane including the X-axis and the Y-axis is appropriately referred to as an XY plane. A plane including the X-axis and the Z-axis is appropriately referred to as an XZ plane. A plane including the Y-axis and the Z-axis is appropriately referred to as a YZ plane. The XY plane is parallel to the horizontal plane. The XY plane, the XZ plane, and the YZ plane are orthogonal to each other.

### Outline of Antenna

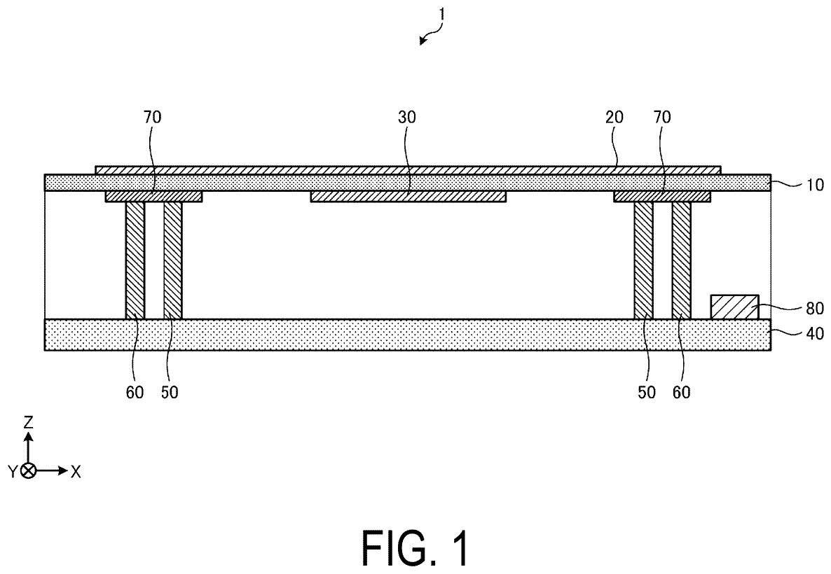

An outline of a configuration example of the antenna according to the embodiment will be described with reference to FIG. 1. FIG. 1 is a diagram for explaining an outline of an antenna according to an embodiment.

As illustrated in FIG. 1, the antenna 1 includes a dielectric substrate 10, a radiation conductor 20, a coupling conductor 30, a mounting substrate 40, a power supply pin 50, a connection pin 60, a connection conductor 70, and a balun 80.

The dielectric substrate 10 is a substrate made of a dielectric material. The dielectric substrate 10 extends in the XY plane direction. In the XY plane direction, the dielectric substrate 10 is disposed in an upper portion in the Z-axis direction. The Z-axis direction is also referred to as a first plane direction. The dielectric substrate 10 may be referred to as a first substrate. A via for electromagnetically connecting the radiation conductor 20 and the coupling conductor 30 is provided in the dielectric substrate 10.

The radiation conductor 20 is made of a metal material. The radiation conductor 20 may be, for example, a resonator configured in a patch shape. The radiation conductor 20 is disposed on the upper surface of the dielectric substrate 10. At least one radiation conductor 20 is disposed on the upper surface of the dielectric substrate 10. The radiation conductor 20 extends in the XY plane direction.

The coupling conductor 30 is made of a metal material. The coupling conductor 30 is disposed on the lower surface of the dielectric substrate 10. The coupling conductor 30 extends in the XY plane. The coupling conductor 30 is configured to capacitively connect the plurality of radiation conductors 20.

The mounting substrate 40 is disposed at a lower portion in the Z-axis direction. The mounting substrate 40 includes a ground conductor and a wiring line. A power supply point for supplying power to the antenna 1 is disposed on the mounting substrate 40. The wiring line is configured such that one end thereof is electromagnetically connected to the power supply point and the other end thereof is electromagnetically connected to the power supply pin 50. In the present embodiment, a dielectric is not included between the dielectric substrate 10 and the mounting substrate 40. That is, a space is formed between the dielectric substrate 10 and the mounting substrate 40. The mounting substrate 40 may be referred to as a second substrate.

The power supply pin 50 is disposed between the dielectric substrate 10 and the mounting substrate 40. The power supply pin 50 is configured such that one end thereof is electromagnetically connected to the connection conductor 70 and the other end thereof is electromagnetically connected to a wiring line provided on the mounting substrate 40. One end of the power supply pin 50 is configured to be electromagnetically connected to the radiation conductor 20 through a via of the dielectric substrate 10. That is, the power supply pin 50 is configured to be electromagnetically connected to the radiation conductor 20 and the mounting substrate 40.

The connection pin 60 is disposed between the dielectric substrate 10 and the mounting substrate 40. The connection pin 60 is configured such that one end thereof is electromagnetically connected to the connection conductor 70 and the other end thereof is electromagnetically connected to a ground conductor provided on the mounting substrate 40. One end of the connection pin 60 is configured to be electromagnetically connected to the radiation conductor 20 through a via of the dielectric substrate 10. That is, the connection pin 60 is configured to be electromagnetically connected to the radiation conductor 20 and the mounting substrate 40.

The balun 80 is disposed on the mounting substrate 40 between the dielectric substrate 10 and the mounting substrate 40. The balun 80 is disposed on the wiring line between the power supply point and the power supply pin 50. The balun 80 performs balanced-unbalanced conversion on the input signal.

In the present embodiment, the balun is disposed on the mounting substrate in the space between the dielectric substrate and the mounting substrate, whereby the configuration of the antenna can be reduced in size.

### First Embodiment

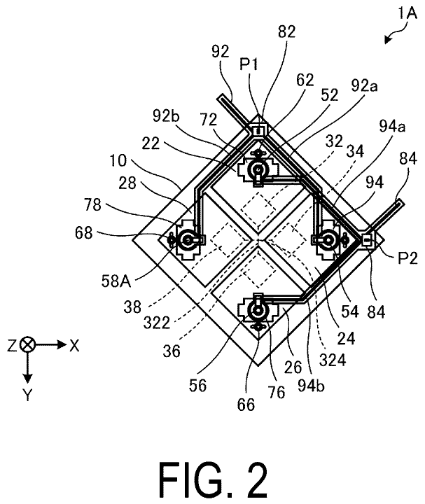

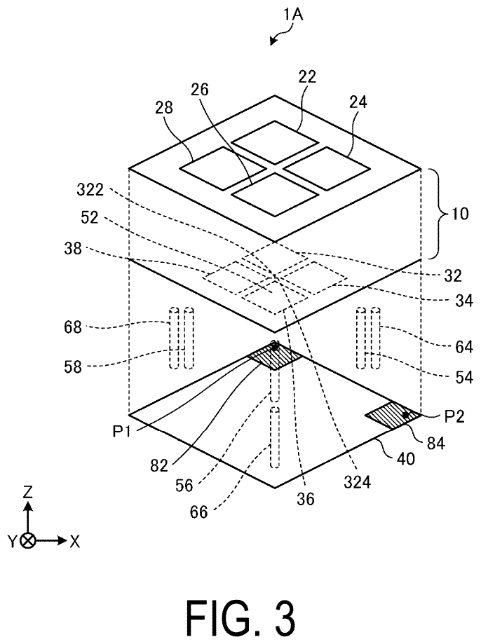

A configuration example of the antenna according to the first embodiment will be described with reference to FIGS. 2 and 3. FIG. 2 is a top view illustrating a configuration example of the antenna according to the first embodiment. FIG. 3 is a perspective view illustrating a configuration example of the antenna according to the first embodiment.

As illustrated in FIGS. 2 and 3, an antenna 1A includes a dielectric substrate 10, a first conductor 22, a second conductor 24, a third conductor 26, a fourth conductor 28, a first coupling conductor 32, a second coupling conductor 34, a third coupling conductor 36, a fourth coupling conductor 38, the mounting substrate 40 including a ground conductor and a wiring line, a first power supply pin 52, a second power supply pin 54, a third power supply pin 56, a fourth power supply pin 58, a first connection pin 62, a second connection pin 64, a third connection pin 66, a fourth connection pin 68, a first connection conductor 72, a second connection conductor 74, a third connection conductor 76, a fourth connection conductor 78, a first balun 82, and a second balun 84. In FIG. 3, the first connection conductor 72, the second connection conductor 74, the third connection conductor 76, and the fourth connection conductor 78 are omitted.

In the present embodiment, the antenna 1A is described as being formed in a quadrangular column shape, but the present disclosure is not limited thereto. The antenna 1A may be formed in a polygonal column shape other than the quadrangular column shape, a circular column shape, an elliptic column shape, or the like.

The antenna 1A is configured to be capable of oscillating at predetermined resonance frequencies. When the antenna 1A oscillates at predetermined resonant frequencies, the antenna 1A radiates electromagnetic waves. The antenna 1A can have an operating frequency in at least one among at least one band of resonant frequencies of the antenna 1A. The antenna 1A may radiate electromagnetic waves at operating frequencies. The wavelengths of the operating frequencies may be operating wavelengths that are wavelengths of electromagnetic waves at the operating frequencies of the antenna 1A.

As will be described later, the antenna 1A exhibits an artificial magnetic conductor character with respect to electromagnetic waves of predetermined frequencies that are incident on a plane substantially parallel to the XY plane of the antenna elements from the positive direction of the Z-axis. In the present disclosure, the “artificial magnetic conductor character” means a characteristic of a surface where a phase difference between an incident wave and a reflected wave at the operating frequency is 0 degrees. On the surface having the artificial magnetic conductor character, the phase difference between the incident wave and the reflected wave in the operating frequency band ranges from −90 degrees to +90 degrees. The operating frequency band includes the resonant frequency and the operating frequency that exhibit the artificial magnetic conductor character.

The first conductor 22, the second conductor 24, the third conductor 26, and the fourth conductor 28 are disposed on the upper surface of the dielectric substrate 10. The first conductor 22, the second conductor 24, the third conductor 26, and the fourth conductor 28 are conductors extending in the XY plane direction. The first conductor 22, the second conductor 24, the third conductor 26, and the fourth conductor 28 are configured as, for example, square resonators. The first conductor 22, the second conductor 24, the third conductor 26, and the fourth conductor 28 are disposed in a square lattice pattern. The first conductor 22, the second conductor 24, the third conductor 26, and the fourth conductor 28 are formed to have substantially the same area in the XY plane.

A gap of a predetermined interval is formed between the first conductor 22 and the second conductor 24. A gap of a predetermined interval is formed between the second conductor 24 and the third conductor 26. A gap of a predetermined interval is formed between the third conductor 26 and the fourth conductor 28. The first conductor 22 to the fourth conductor 28 are configured to be capacitively connected to each other.

The first conductor 22, the second conductor 24, the third conductor 26, and the fourth conductor 28 are described as being formed in a square shape, but the present disclosure is not limited thereto. The first conductor 22, the second conductor 24, the third conductor 26, and the fourth conductor 28 may have, for example, a polygonal shape other than a square shape, a circular shape, or an elliptical shape. The first conductor 22, the second conductor 24, the third conductor 26, and the fourth conductor 28 may be different from each other in at least one of area and shape in the XY plane.

The first coupling conductor 32, the second coupling conductor 34, the third coupling conductor 36, and the fourth coupling conductor 38 are disposed on the lower surface of the dielectric substrate 10. The first coupling conductor 32, the second coupling conductor 34, the third coupling conductor 36, and the fourth coupling conductor 38 are conductors extending in the XY plane direction. The first coupling conductor 32 and the third coupling conductor 36 are configured to be electromagnetically connected to each other by a connection portion 322. The connection portion 322 may be a thin wire of a conductor. The third coupling conductor 36 and the fourth coupling conductor 38 are configured to be electromagnetically connected to each other by a connection portion 324.

A gap of a predetermined interval is formed between the first coupling conductor 32 and the second coupling conductor 34. A gap of a predetermined interval is formed between the second coupling conductor 34 and the third coupling conductor 36. A gap of a predetermined interval is formed between the third coupling conductor 36 and the fourth coupling conductor 38. The first coupling conductor 32, the second coupling conductor 34, the third coupling conductor 36, and the fourth coupling conductor 38 are formed in, for example, a square shape. The first coupling conductor 32, the second coupling conductor 34, the third coupling conductor 36, and the fourth coupling conductor 38 are formed to have substantially the same area in the XY plane.

The first coupling conductor 32 is disposed facing the first conductor 22. For example, the first coupling conductor 32 is disposed entirely overlapping the first conductor 22. For example, the first coupling conductor 32 may be disposed such that at least a portion of the first coupling conductor 32 overlaps the first conductor 22. For example, the area of the first coupling conductor 32 in the XY plane is smaller than the area of the first conductor 22 in the XY plane. The first coupling conductor 32 is configured to be capacitively connected to the first conductor 22.

The second coupling conductor 34 is disposed facing the second conductor 24. For example, the second coupling conductor 34 is disposed entirely overlapping the second conductor 24. For example, the second coupling conductor 34 may be disposed such that at least a portion of the second coupling conductor 34 overlaps the second conductor 24. For example, the area of the second coupling conductor 34 in the XY plane is smaller than the area of the second conductor 24 in the XY plane. The second coupling conductor 34 is configured to be capacitively connected to the second conductor 24.

The third coupling conductor 36 is disposed facing the third conductor 26. For example, the third coupling conductor 36 is disposed entirely overlapping the third conductor 26. For example, the third coupling conductor 36 may be disposed such that at least a portion of the third coupling conductor 36 overlaps the third conductor 26. For example, the area of the third coupling conductor 36 in the XY plane is smaller than the area of the third conductor 26 in the XY plane. The third coupling conductor 36 is configured to be capacitively connected to the third conductor 26.

The fourth coupling conductor 38 is disposed facing the fourth conductor 28. For example, the fourth coupling conductor 38 is disposed entirely overlapping the fourth conductor 28. For example, the fourth coupling conductor 38 may be disposed such that at least a portion of the fourth coupling conductor 38 overlaps the fourth conductor 28. For example, the area of the fourth coupling conductor 38 in the XY plane is smaller than the area of the fourth conductor 28 in the XY plane. The fourth coupling conductor 38 is configured to be capacitively connected to the fourth conductor 28.

Although the first coupling conductor 32, the second coupling conductor 34, the third coupling conductor 36, and the fourth coupling conductor 38 are described as being formed in a square shape, the present disclosure is not limited thereto. The first coupling conductor 32, the second coupling conductor 34, the third coupling conductor 36, and the fourth coupling conductor 38 may have, for example, a polygonal shape other than a square shape, a circular shape, or an elliptical shape. The first coupling conductor 32, the second coupling conductor 34, the third coupling conductor 36, and the fourth coupling conductor 38 may be different from each other in at least one of area and shape in the XY plane. The first coupling conductor 32, the second coupling conductor 34, the third coupling conductor 36, and the fourth coupling conductor 38 may be different in shape from the first conductor 22, the second conductor 24, the third conductor 26, and the fourth conductor 28, respectively.

The mounting substrate 40 is disposed below the dielectric substrate 10. A space is formed between the mounting substrate 40 and the dielectric substrate 10. A ground conductor (not illustrated) is provided on the mounting substrate 40. The mounting substrate 40 is formed in, for example, a quadrangular shape. The mounting substrate 40 includes a power supply point P1 and a power supply point P2. The power supply point P1 may be formed, for example, at one of the four corners of the mounting substrate 40. The power supply point P2 is formed, for example, at one corner adjacent to the corner at which the power supply point P1 is formed among the four corners of the mounting substrate 40.

A first balun 82 is disposed at the power supply point P1. That is, the first balun 82 is disposed inside the antenna 1A. The first balun 82 is configured to be capable of outputting two electrical signals having phases opposite to each other based on one input electrical signal. One end of a cable 92 is electromagnetically connected to the power supply point P1. The other end of the cable 92 is electromagnetically connected to an external device. The antenna 1A is configured to input and output signals to and from an external device by the cable 92 via the first balun 82. The first balun 82 is configured to be capable of outputting two electrical signals having phases opposite to each other based on one electrical signal input from the cable 92.

A second balun 84 is disposed at the power supply point P2. In other words, the second balun 84 is disposed inside the antenna 1A. The second balun 84 is configured to be capable of outputting two electrical signals having phases opposite to each other based on the input electrical signal. One end of a cable 94 is electromagnetically connected to the power supply point P1. The other end of the cable 94 is electromagnetically connected to an external device. The antenna 1A is configured to input and output a signal to and from an external device by the cable 94 via the second balun 84. The second balun 84 is configured to be capable of outputting two electrical signals having opposite phases to each other based on one electrical signal input from the cable 94.

The mounting substrate 40 includes a wiring line 92a, a wiring line 92b, a wiring line 94a, and a wiring line 94b. The wiring line 92a, the wiring line 92b, the wiring line 94a, and the wiring line 94b are wiring line patterns formed on the mounting substrate 40.

One end of the wiring line 92a is electromagnetically connected to the first balun 82, and the other thereof end is electromagnetically connected to the connection position of the second power supply pin 54. One end of the wiring line 92b is electromagnetically connected to the first balun 82, and the other thereof end is electromagnetically connected to the connection position of the fourth power supply pin 58. That is, electrical signals having opposite phases may be input to the second power supply pin 54 and the fourth power supply pin 58.

One end of the wiring line 94a is electromagnetically connected to the second balun 84, and the other thereof end is electromagnetically connected to the connection position of the first power supply pin 52. One end of the wiring line 94b is electromagnetically connected to the second balun 84, and the other thereof end is electromagnetically connected to the connection position of the third power supply pin 56. That is, electrical signals having opposite phases may be input to the first power supply pin 52 and the third power supply pin 56.

The first power supply pin 52, the second power supply pin 54, the third power supply pin 56, and the fourth power supply pin 58 are cylindrical pin members that are located between the dielectric substrate 10 and the mounting substrate 40 and are parallel to the Z-axis direction.

The first power supply pin 52 is configured to be located between the first conductor 22 and the mounting substrate 40. The first power supply pin 52 is configured to electromagnetically connect the first conductor 22 and the power supply point P2. The first power supply pin 52 is configured such that one end thereof is electromagnetically connected to a first connection conductor 72 provided on the lower surface of the dielectric substrate 10 facing the first conductor 22, and the other end thereof is electromagnetically connected to the other end of the wiring line 94a. The first connection conductor 72 can be formed outside the first coupling conductor 32 in the XY plane. The first connection conductor 72 may have an arbitrary shape. The first conductor 22 and the first connection conductor 72 are configured to be electromagnetically connected by, for example, a via. Thus, the one end of the first power supply pin 52 is electromagnetically connected to the first connection conductor 72, whereby the first conductor 22 and the power supply point P2 are electromagnetically connected to each other.

The second power supply pin 54 is configured to be located between the second conductor 24 and the mounting substrate 40. The second power supply pin 54 is configured to electromagnetically connect the second conductor 24 and the power supply point P1. The second power supply pin 54 is configured such that one end thereof is electromagnetically connected to a second connection conductor 74 provided on the lower surface of the dielectric substrate 10 facing the second conductor 24, and the other end thereof is electromagnetically connected to the other end of the wiring line 92a. The second connection conductor 74 can be formed outside the second coupling conductor 34 in the XY plane. The second connection conductor 74 may have an arbitrary shape. The second conductor 24 and the second connection conductor 74 are configured to be electromagnetically connected by, for example, a via. Thus, the one end of the second power supply pin 54 is electromagnetically connected to the second connection conductor 74, whereby the second conductor 24 and the power supply point P1 are electromagnetically connected.

The third power supply pin 56 is configured to be located between the third conductor 26 and the mounting substrate 40. The third power supply pin 56 is configured to electromagnetically connect the third conductor 26 and the power supply point P2. The third power supply pin 56 is configured such that one end thereof is electromagnetically connected to a third connection conductor 76 provided on the lower surface of the dielectric substrate 10 facing the third conductor 26, and the other end thereof is electromagnetically connected to the other end of the wiring line 94b. The third connection conductor 76 can be formed outside the third coupling conductor 36 in the XY plane. The third connection conductor 76 may have an arbitrary shape. The third conductor 26 and the third connection conductor 76 are configured to be electromagnetically connected to each other by a via, for example. Thus, the one end of the third power supply pin 56 is electromagnetically connected to the third connection conductor 76, whereby the third conductor 26 and the power supply point P2 are electromagnetically connected to each other.

The fourth power supply pin 58 is configured to be located between the fourth conductor 28 and the mounting substrate 40. The fourth power supply pin 58 is configured to electromagnetically connect the fourth conductor 28 and the power supply point P1. The fourth power supply pin 58 is configured such that one end thereof is electromagnetically connected to the fourth connection conductor 78 provided on the lower surface of the dielectric substrate 10 facing the fourth conductor 28, and the other end thereof is electromagnetically connected to the other end of the wiring line 92b. The fourth connection conductor 78 can be formed outside the fourth coupling conductor 38 in the XY plane. The fourth connection conductor 78 may have an arbitrary shape. The fourth conductor 28 and the fourth connection conductor 78 are configured to be electromagnetically connected by, for example, a via. Thus, the one end of the fourth power supply pin 58 is electromagnetically connected to the fourth connection conductor 78, whereby the fourth conductor 28 and the power supply point P1 are electromagnetically connected to each other.

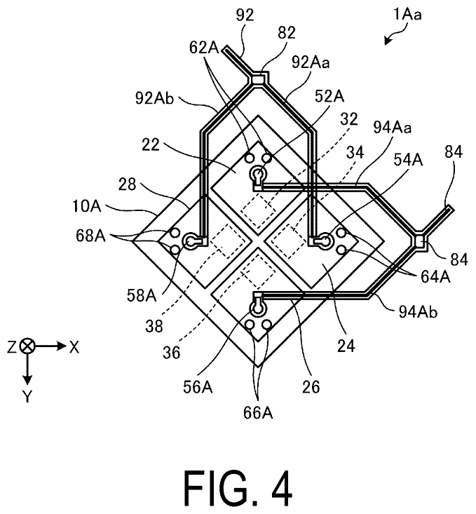

That is, in the first embodiment, all of the wiring lines connecting the first conductor 22, the second conductor 24, the third conductor 26, and the fourth conductor 28 to the power supply point P1 and the power supply point P2 are included in the mounting substrate 40. Here, a wiring line pattern according to a comparative example will be described with reference to FIG. 4. FIG. 4 is a diagram for explaining a wiring line pattern according to a comparative example.

As illustrated in FIG. 4, an antenna 1Aa according to the comparative example includes the dielectric substrate 10, the first conductor 22, the second conductor 24, the third conductor 26, the fourth conductor 28, the first coupling conductor 32, the second coupling conductor 34, the third coupling conductor 36, the fourth coupling conductor 38, the mounting substrate 40, a first power supply via 52A, a second power supply via 54A, a third power supply via 56A, a fourth power supply via 58A, a first connection via 62A, a second connection via 64A, a third connection via 66A, a fourth connection via 68A, the first balun 82, and the second balun 84. In the antenna 1Aa, the dielectric substrate 10A is formed from the lower surfaces of the first conductor 22, the second conductor 24, the third conductor 26, and the fourth conductor 28 to the mounting substrate 40.

The first power supply via 52A, the second power supply via 54A, the third power supply via 56A, and the fourth power supply via 58A are vias formed in the dielectric substrate 10A. The first connection via 62A, the second connection via 64A, the third connection via 66A, and the fourth connection via 68A are vias formed in the dielectric substrate 10A.

The first power supply via 52A is configured such that one end thereof is electromagnetically connected to the first conductor 22 and the other end thereof is electromagnetically connected to a wiring line 94Aa. The second power supply via 54A is configured such that one end thereof is electromagnetically connected to the second conductor 24 and the other end thereof is electromagnetically connected to a wiring line 92Aa. The third power supply via 56A is configured such that one end thereof is electromagnetically connected to the third conductor 26 and the other end thereof is electromagnetically connected to the wiring line 94Ab. The fourth power supply via 58A is configured such that one end thereof is electromagnetically connected to the fourth conductor 28 and the other end thereof is electromagnetically connected to the wiring line 94Ab.

The first connection via 62A is configured such that one end thereof is electromagnetically connected to the first conductor 22 and the other end thereof is electromagnetically connected to the ground conductor. The second connection via 64A is configured such that one end thereof is electromagnetically connected to the second conductor 24 and the other end thereof is electromagnetically connected to the ground conductor. The third connection via 66A is configured such that one end thereof is electromagnetically connected to the third conductor 26 and the other end thereof is electromagnetically connected to the ground conductor. The fourth connection via 68A is configured such that one end thereof is electromagnetically connected to the fourth conductor 28 and the other end thereof is electromagnetically connected to the ground conductor.

As illustrated in FIG. 4, the first balun 82 and the second balun 84 are disposed outside the mounting substrate 40.

The wiring line 92Aa is configured such that one end thereof is electromagnetically connected to the first balun 82 and the other end thereof is electromagnetically connected to the other end of the second power supply via 54A. The wiring line 92Ab is configured such that one end thereof is electromagnetically connected to the first balun 82 and the other end thereof is electromagnetically connected to the other end of the fourth power supply via 58A. The wiring line 94Aa is configured such that one end thereof is electromagnetically connected to the second balun 84 and the other end thereof is electromagnetically connected to the other end of the first power supply via 52A. The wiring line 94Ab is configured such that one end thereof is electromagnetically connected to the second balun 84 and the other end thereof is electromagnetically connected to the fourth power supply via 58A.

Since the first balun 82 and the second balun 84 are disposed outside the mounting substrate 40, the wiring line 92Aa, the wiring line 92Ab, the wiring line 94Aa, and the wiring line 94Ab are longer than the wiring line 92a, the wiring line 92b, the wiring line 94a, and the wiring line 94b illustrated in FIG. 2, respectively.

That is, in the first embodiment, by disposing the first balun 82 and the second balun 84 inside the antenna 1A, the wiring line 92a, the wiring line 92b, the wiring line 94a, and the wiring line 94b can be shortened compared to the comparative example. As a result, the first embodiment can realize an antenna that is smaller in size and lower in loss than the comparative example.

The first connection pin 62, the second connection pin 64, the third connection pin 66, and the fourth connection pin 68 are cylindrical pin members that are located between the dielectric substrate 10 and the mounting substrate 40 and are parallel to the Z-axis direction.

The first connection pin 62 is configured to be located between the first conductor 22 and the mounting substrate 40. The first connection pin 62 is configured to be located outside the first power supply pin 52 in the XY plane. The first connection pin 62 is configured to electromagnetically connect the first conductor 22 and the ground conductor. For example, the first connection pin 62 is configured such that one end thereof is electromagnetically connected to the first connection conductor 72 and the other end thereof is connected to the ground conductor. Thus, the first conductor 22 and the ground conductor are electromagnetically connected to each other.

The second connection pin 64 is configured to be located between the second conductor 24 and the mounting substrate 40. The second connection pin 64 is configured to be located outside the second power supply pin 54 in the XY plane. The second connection pin 64 is configured to electromagnetically connect the second conductor 24 and the ground conductor. For example, the second connection pin 64 is configured such that one end thereof is electromagnetically connected to the second connection conductor 74 and the other end thereof is connected to the ground conductor. Accordingly, the second conductor 24 and the ground conductor are electromagnetically connected to each other.

The third connection pin 66 is configured to be located between the third conductor 26 and the mounting substrate 40. The third connection pin 66 is configured to be located outside the third power supply pin 56 in the XY plane. The third connection pin 66 is configured to electromagnetically connect the third conductor 26 and the ground conductor. For example, the third connection pin 66 is configured such that one end thereof is electromagnetically connected to the third connection conductor 76 and the other end thereof is connected to the ground conductor. Thus, the third conductor 26 and the ground conductor are electromagnetically connected to each other.

The fourth connection pin 68 is configured to be located between the fourth conductor 28 and the mounting substrate 40. The fourth connection pin 68 is configured to be located outside the fourth power supply pin 58 in the XY plane. The fourth connection pin 68 is configured to electromagnetically connect the fourth conductor 28 and the ground conductor. For example, the fourth connection pin 68 is configured such that one end thereof is electromagnetically connected to the fourth connection conductor 78 and the other end thereof is connected to the ground conductor. Thus, the fourth conductor 28 and the ground conductor are electromagnetically connected to each other.

The first connection pin 62, the second connection pin 64, the third connection pin 66, and the fourth connection pin 68 are configured to surround the first conductor 22, the second conductor 24, the third conductor 26, and the fourth conductor 28 in the XY plane. The first conductor 22, the second conductor 24, the third conductor 26, and the fourth conductor 28 are configured to capacitively connect the first connection pin 62, the second connection pin 64, the third connection pin 66, and the fourth connection pin 68.

The first connection pin 62 and the third connection pin 66 are supplied with electrical signals having phases opposite to each other from the second balun 84. In other words, electrical signals having phases opposite to each other are supplied to the first conductor 22 and the third conductor 26. Thereby, the first conductor 22 and the third conductor 26 can resonate in the X-axis direction. When the first conductor 22 and the third conductor 26 resonate in the X-axis direction, the first connection pin 62 is seen as an electric wall located on the negative direction side of the X-axis, and the third connection pin 66 is seen as an electric wall located on the positive direction side of the X-axis. When the first conductor 22 and the third conductor 26 resonate in the X-axis direction, the positive direction side and the negative direction side in the Y-axis direction are seen as magnetic walls. That is, when the first conductor 22 and the third conductor 26 resonate in the X-axis direction, the first conductor 22, the second conductor 24, the third conductor 26, and the fourth conductor 28 are surrounded by two electric walls and two magnetic walls. Accordingly, the antenna 1A is configured to exhibit the artificial magnetic conductor character with respect to electromagnetic waves of predetermined frequencies incident on the XY plane included in the antenna 1A from the positive direction side in the Z-axis direction.

The second connection pin 64 and the fourth connection pin 68 are supplied with electrical signals having phases opposite to each other from the first balun 82. In other words, electrical signals having phases opposite to each other are supplied to the second conductor 24 and the fourth conductor 28. Thereby, the second conductor 24 and the fourth conductor 28 can resonate in the Y-axis direction. When the second conductor 24 and the fourth conductor 28 resonate in the Y-axis direction, the fourth connection pin 68 is seen as an electric wall located on the negative direction side of the Y-axis, and the second connection pin 64 is seen as an electric wall located on the positive direction side of the Y-axis. When the second conductor 24 and the fourth conductor 28 resonate in the Y-axis direction, the positive direction side and the negative direction side in the X-axis direction are seen as magnetic walls. That is, when the second conductor 24 and the fourth conductor 28 resonate in the Y-axis direction, the first conductor 22, the second conductor 24, the third conductor 26, and the fourth conductor 28 are surrounded by two electric walls and two magnetic walls. As a result, the antenna 1A is configured to exhibit the artificial magnetic conductor character with respect to electromagnetic waves of predetermined frequencies incident on the XY plane included in the antenna 1A from the negative direction side in the Z-axis direction.

As described above, in the first embodiment, since a space is formed between the dielectric substrate 10 and the mounting substrate 40, the first balun 82 and the second balun 84 can be disposed on the mounting substrate 40 between the dielectric substrate 10 and the mounting substrate 40. Thus, the first embodiment can realize size reduction.

### Second Embodiment

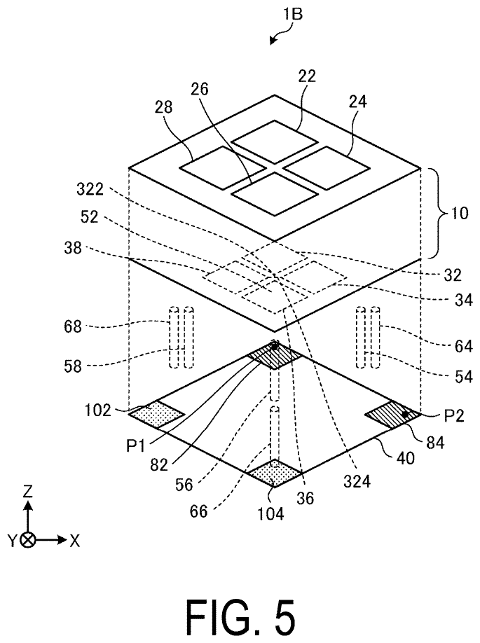

A second embodiment of the present disclosure will be described. FIG. 5 is a perspective view illustrating a configuration example of the antenna according to the second embodiment.

As illustrated in FIG. 5, an antenna 1B according to the second embodiment is different from the antenna 1A illustrated in FIGS. 2 and 3 in that the antenna 1B includes a first dummy balun 102 and a second dummy balun 104.

The first dummy balun 102 is disposed at one of the four corners of the mounting substrate 40 other than the corner at which the first balun 82 and the second balun 84 are disposed. In the example illustrated in FIG. 5, the first dummy balun 102 is disposed at a corner adjacent to the corner at which the first balun 82 is disposed.

The second dummy balun 104 is disposed at the remaining corners of the four corners of the mounting substrate 40. In the example illustrated in FIG. 5, the second dummy balun 104 is disposed at a corner adjacent to the corner at which the second balun 84 is disposed.

The first dummy balun 102 and the second dummy balun 104 have the same shapes as the first balun 82 and the second balun 84, respectively. That is, the first balun 82, the second balun 84, the first dummy balun 102, and the second dummy balun 104 each have the same shape.

Each of the first dummy balun 102 and the second dummy balun 104 is made of a metal piece. The first dummy balun 102 and the second dummy balun 104 are each soldered onto the mounting substrate 40.

Specifically, the first dummy balun 102 and the second dummy balun 104 are disposed at positions rotationally symmetric to the first balun 82 and the second balun 84 with respect to the center of the mounting substrate 40 in the XY plane.

By disposing the first balun 82 and the second balun 84 inside the antenna, the rotational symmetry of the antenna in the XY plane is lost. Therefore, in the second embodiment, the first dummy balun 102 and the second dummy balun 104 are disposed to maintain rotational symmetry in the XY plane. As a result, in the second embodiment, deterioration of characteristics which may occur due to collapse of rotational symmetry in the XY plane can be suppressed.

### Variation of Second Embodiment

In the second embodiment, the first dummy balun 102 and the second dummy balun 104 are described as being metal pieces, but the present disclosure is not limited thereto.

For example, the first dummy balun 102 and the second dummy balun 104 may be made of dielectric pieces having the same shapes as those of the first balun 82 and the second balun 84, respectively. When the first dummy balun 102 and the second dummy balun 104 are made of metal pieces, a difference in thermal conductivity may occur between the first balun 82 and the second balun 84 and between the first dummy balun 102 and the second dummy balun 104. Therefore, inside the antenna 1B, the temperature distribution may become uneven, and the characteristics of the antenna 1B may become unstable.

When the first dummy balun 102 and the second dummy balun 104 are made of a dielectric material, the difference in thermal conductivity between the first balun 82 and the second balun 84 and the first dummy balun 102 and the second dummy balun 104 can be reduced. Thus, the difference in temperature distribution inside the antenna 1B can be reduced. As a result, the variation of the second embodiment can stabilize the characteristics of the antenna 1B.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1, 1A, 1B Antenna
10 Dielectric substrate
20 Radiation conductor
22 First conductor
24 Second conductor
26 Third conductor
28 Fourth conductor
30 Coupling conductor
32 First coupling conductor
34 Second coupling conductor
36 Third coupling conductor
38 Fourth coupling conductor
40 Mounting substrate
50 Power supply pin
52 First power supply pin
52A First power supply via
54 Second power supply pin
54A Second power supply via
56 Third power supply pin
56A Third power supply via
58 Fourth power supply pin
58A Fourth power supply via
62 First connection pin
62A First connection via
64 Second connection pin
64A Second connection via
66 Third connection pin
66A Third connection via
68 Fourth connection pin
68A Fourth connection via
72 First connection conductor
74 Second connection conductor
76 Third connection conductor
78 Fourth connection conductor
82 First balun
84 Second balun
92, 94 Cable
92a, 92Aa, 92b, 92Ab, 94a, 94Aa, 94b, 94Ab Wiring line
102 First dummy balun
104 Second dummy balun

1. An antenna comprising:
a first substrate extending in a first plane direction;
a first conductor, a second conductor, a third conductor, and a fourth conductor that are disposed on one surface of the first substrate and extend in the first plane direction;
a coupling conductor disposed on another surface of the first substrate, the coupling conductor extending in the first plane direction, the coupling conductor capacitively coupling the first conductor, the second conductor, the third conductor, and the fourth conductor;
a second substrate comprising a ground conductor and a power supply point, the second substrate being separated from the first substrate in a first direction, the second substrate comprising one surface facing the other surface of the first substrate, the second substrate extending in the first plane direction;
a first pin member configured to electromagnetically connect to the first conductor;
a second pin member configured to electromagnetically connect to the second conductor;
a third pin member configured to electromagnetically connect to the third conductor;
a fourth pin member configured to electromagnetically connect to the fourth conductor; and
a balun disposed on one surface of the second substrate to be electromagnetically connected to the power supply point.

2. The antenna according to claim 1, wherein
the power supply point comprises a first power supply point and a second power supply point, and
the balun comprises a first balun configured to be electromagnetically connected to the first power supply point and a second balun configured to be electromagnetically connected to the second power supply point.

3. The antenna according to claim 2, further comprising:
a first dummy balun and a second dummy balun on a front surface of the second substrate, wherein
the first dummy balun and the second dummy balun are disposed at positions rotationally symmetric to the first balun and the second balun, respectively, with respect to a center of the second substrate in the first plane direction.

4. The antenna according to claim 3, wherein
the first dummy balun and the second dummy balun are metal pieces having substantially the same volumes as the first balun and the second balun, respectively.

5. The antenna according to claim 3, wherein
the first dummy balun and the second dummy balun are dielectrics having substantially the same volumes as the first balun and the second balun, respectively.

6. The antenna according to claim 1, wherein
the balun, the first pin member, the second pin member, the third pin member, and the fourth pin member are configured to be electromagnetically connected to each other by a wiring line formed on the second substrate.
